(19) United States
(12) Patent Application Publication
(10) Pub. No.: US 2010/0306146 A1
(43) Pub. Date: Dec. 2, 2010

(54) NON-SUBSCRIPTION BASED SERVICE FOR PROVIDING CONTEXTUALLY-PREFERRED NEW CONTENT TO INFORMATION SYSTEM USERS

(75) Inventors: Eric M. Brown, Research Triangle Park, NC (US); Ronny A. Pena, New York, NY (US); Ajamu A. Wesley, Westford, MA (US)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 12/474,878

(22) Filed: May 29, 2009

(51) Int. Cl. G06N 5/00

(52) U.S. Cl. 706/45

(57) ABSTRACT

A non-subscription based system that can provide contextually-preferred content to information system users, include an online information system, and a preferred content service provider. The online information system can be configured to provide users with access to content items. Each content item can be associated with a specific content creator registered with the online information system and/or a specific organizational location of the online information system. The preferred content service provider can be configured to provide a content preference service to users of the online information system. The content preference service can be configured to provide a user with a recommendation listing of content items from the online information system that satisfies a predetermined level of user preference without the use of a subscription mechanism. The recommendation listing can be dynamically updated when new content items meeting the predetermined level of user preference become available in the online information system.

### BACKGROUND

The present invention relates to the field of information systems and, more particularly, to a non-subscription based technique for providing contextually-preferred new content to information system users.

Online information systems, such as intranets, social networking systems, and online collaboration systems, provide a user-friendly environment for sharing a variety of data content among a large audience of users. The continuous growth of content items contained within an online information system creates many issues that hinder a user's ability to find and/or utilize content that is relevant to their interests in a timely manner.

A variety of tools have been created in the attempt to provide users with relevant or preferred content from an online information system. Search function algorithms typically include a relevance rating of a content item matching the search criteria. However, this approach relies upon the user's choice of search criteria and disregards the contextual usage of the content item. Further, because this approach must be manually executed on content store of the information system, a user must be vigilant in the timeliness of conducting searches in order to find new content items of relevance.

Subscription-based approaches such as those that utilize Really Simple Syndication (RSS) feeds attempt to solve the problem of timeliness by automatically providing new content items to users for specific content provider to which they have subscribed. However, this approach requires that the user subscribe to specific content providers and provides all the content from that content provider regardless of relevance. Therefore, a user is often provided with more content than necessary and must manually search through the content to determine relevance.

### BRIEF SUMMARY

One aspect of the present invention can include a non-subscription based system for providing contextually-preferred content to information system users. Such a system can include an online information system and a preferred content service provider. The online information system can be configured to provide users with access to content items. Each content item can be associated with a specific content creator registered with the online information system and/or a specific organizational location of the online information system. The preferred content service provider can be configured to provide a content preference service to users of the online information system. The content preference service can be configured to provide a user with a recommendation listing of content items from the online information system that satisfy a predetermined level of user preference without the use of a subscription mechanism. The recommendation listing can be dynamically updated when new content items meeting the predetermined level of user preference become available in the online information system.

Another aspect of the present invention can include a method for providing contextually-preferred content to information system users. The existence of a new content item within an online information system can be detected. The new content item can have associated contextual characteristics which can include an identifier of the creator, one or more textual tags, a user rating, and a location within the online information system. In response to the detection, the satisfaction of a predetermined level of user preference by the contextual characteristics of the new content item can be determined. This determination can be performed for each user of the online information system that has a value defined for the predetermined level of user preference. When the new content item satisfies the predetermined level of user preference, a dynamically generated recommendation listing that details the availability of the new content item can be provided to the user with in a user interface of the online information system. The dynamically generated recommendation listing can be provided without prompting by a subscription mechanism.

Yet another aspect of the present invention can include a non-subscription based online information system service for automatically providing contextually-preferred content to users. This non-subscription based online information system service can include a computer readable storage medium that includes embedded computer usable program code. The computer usable program code can be configured to detect the existence of a new content item within an online information system. The new content item can have associated contextual characteristics which can include an identifier of the creator, one or more textual tags, a user rating, and a location within the online information system. In response to the detection, the computer usable program code can be configured to determine the satisfaction of a predetermined level of user preference by the contextual characteristics of the new content item. This determination can be performed for each user of the online information system that has a value defined for the predetermined level of user preference. When the new content item satisfies the predetermined level of user preference for a user, the computer usable program code can be configured to provide the user with a dynamically generated recommendation listing that details the availability of the new content item within a user interface of the online information system. The dynamically generated recommendation listing can be provided without prompting by a subscription mechanism.

### BRIEF DESCRIPTION OF THE SEVERAL VIEWS OF THE DRAWINGS

FIG. 1 is a schematic diagram illustrating a non-subscription based system that utilizes a content preference service to provide contextually-preferred content items to users of an online information system in accordance with embodiments of the inventive arrangements disclosed herein.

FIG. 2 is a schematic diagram illustrating two data flows of a system that utilizes a non-subscription based service to provide contextually-preferred content to information system users in accordance with an embodiment of the inventive arrangements disclosed herein.

FIG. 3 is a collection of graphical user interfaces (GUIs) for an online information system that illustrate content preference service features in accordance with an embodiment of the inventive arrangements disclosed herein.

FIG. 4 is a flow chart of a method that describes the basic operation of a non-subscription based content preference service in accordance with embodiments of the inventive arrangements disclosed herein.

### DETAILED DESCRIPTION

The present invention discloses a solution that utilizes a non-subscription based service to provide contextually-preferred content to information system users. This solution can utilize a content preference mechanism that can be incorporated into the user interface of the information system. As a user indicates preferences for existing content items, the contextual characteristics of the content item can be captured and stored as user-defined content notification preferences. The user-defined content notification preferences can define a level of user preference for content items and can be utilized by the content preference service to assess the relevance of new content items for a user. New content items that satisfy the user's preference level can be automatically presented to the user within a content recommendation display that can be integrated into the user interface of the information system. The content recommendation display can be updated dynamically and asynchronously.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

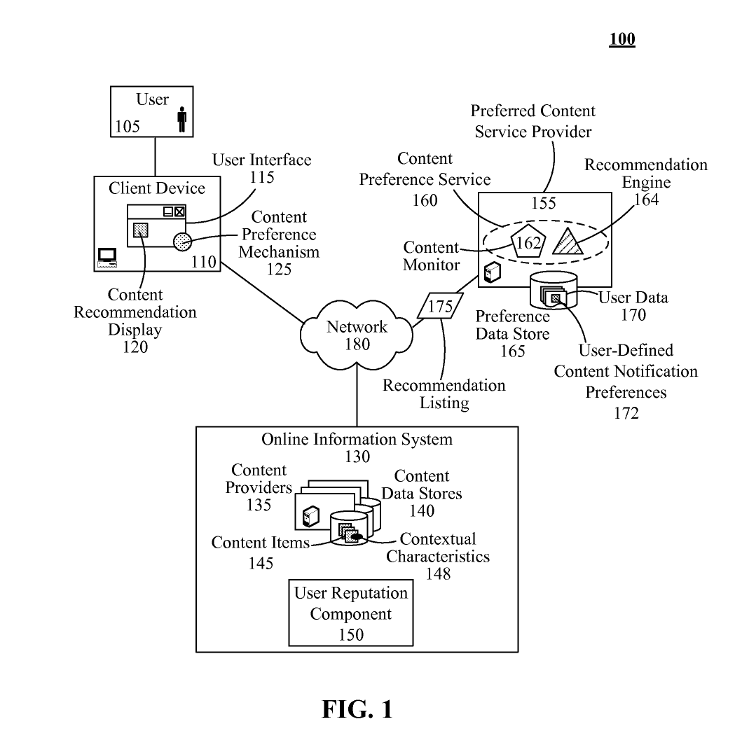

FIG. 1 is a schematic diagram illustrating a non-subscription based system 100 that utilizes a content preference service 160 to provide contextually-preferred content items 145 to users 105 of an online information system 130 in accordance with embodiments of the inventive arrangements disclosed herein. In system 100, a user 105 can be automatically and dynamically presented with contextually-preferential content items 145 contained within an online information system 130 by a content preference service 160 without the use of a subscription mechanism.

The user 105 can interact with the online information system 130 over the network 180 using a user interface 115 running on a client device 110. The client device 110 can represent a variety of electronic computing devices capable of running the user interface 115 and communicating with the online information system 130 and preferred content service provider 155 over the network 180.

The online information system 130 can represent a variety of computing systems that can be configured to facilitate information sharing, such as an online collaboration system, a file sharing system, a social networking system, and the like. The online information system 130 can be configured to operate in conjunction with the content preference service 160 of the preferred content service provider 155. The online information system 130 can include one or more content providers 135 and a user reputation component 150.

A content provider 135 can correspond to the hardware and/or software components necessary to provide content items 145 to users 105 over the network 180. Each content provider 135 can include an associated content data store 140 containing the associated content items 145. Further, each content provider 135 can correspond to a separate type of content, such as a Web server, a WIKI server, and a file server.

A content item 145 can represent a specific data entry of the type supported by the content provider 135. For example, a Web page is a content item 145 of a Web server 135, an uploaded file is a content item 145 of a file server 135, and so on. Each content item 145 can have associated contextual characteristics 148. A contextual characteristic 148 can represent a piece of data that defines the context of the content item 145 within the online information system 130. Examples of contextual characteristics 148 can include, but are not limited to, keyword, tags, file type, creator, location, title, and the like.

It should be emphasized that the term “contextual characteristic”, as used herein, abstractly refers to various informational data items that can be known about the content item 145. Some contextual characteristics 148 can be defined by the user 105, such as tags, and others concretely defined within the online information system 130, such as file location. Thus, the contextual characteristics 148 do not exist as data aggregate attached to a specific content item 145.

The preferred content service provider 155 can represent the hardware and/or software components necessary to interact with the online information system 130 to provide the content preference service 160. Communication and data exchanges between the preferred content service provider 155 and the online information system 130 can utilize standardized data exchange and communication protocols, such as Simple Object Access Protocol (SOAP) and Representational State Transfer (REST).

In another contemplated embodiment, the preferred content service provider 155 can be an integrated component of the online information system 130.

The content preference service 160 can represent the means by which a user 105 can be provided with contextually-preferred content items 145 from the online information system 130. It is critical to stress that the content preference service 160 does not utilize a subscription mechanism; the user 105 does not subscribe to the content preference service 160 or the content providers 135 of the online information system 130.

The content preference service 160 can include a content monitor 162, a recommendation engine 164 and utilize the contents of the preference data store 165. The content monitor 162 can represent a software component that can be configured to detect the addition of new content items 145 to the online information system 130.

The recommendation engine 164 can represent a software component that can be configured to utilize the user-defined content notification preferences 172 contained within the preferences data store 165 to determine if a new content item 145 is preferred by a user 105. Content items 145 determined by the recommendation engine 164 to be preferred by a user 105 can be placed in a recommendation listing 175 that can be displayed in the content recommendation display 120 of the user interface 115 of the online information system 130.

Because the content preference service 160 reacts to the addition of new content items 145 to the online information system 130, the recommendation listing 175 presented in the content recommendation display 120 can be dynamically updated. Further, content recommendation display 120 can be updated asynchronously from other elements of the user interface 115 that are in use by the user 105. For example, as a user 105 is reading a colleague's blog, the content recommendation display 120 can be refreshed without disrupting viewing of the blog.

The user-defined content notification preferences 172 can represent a user's 105 preferences for content items 145 contained within the online information system 130. The user-defined content notification preferences 172 can be written in terms of the contextual characteristics 148 of the context items 145. For example, a user-defined content notification preference 172 can indicate a preference for blog entries 145 having the tag “ECLIPSE” 148.

In another embodiment, the user-defined content notification preferences 172 can be configured to allow for the individual weighting of the user-defined content notification preferences 172 as well as the definition of an overall preference threshold.

The user-defined content notification preferences 172 can be collected utilizing a content preference mechanism 125 that can be integrated within the user interface 115 of the online information system 130. The content preference service 160 can store the user-defined content notification preferences 172 entered via the content preference mechanism 125 into the preferences data store 165 as user data 170 for the specific user 105.

Additionally, the user-defined content notification preferences 172 can be utilized by the user reputation component 150 of the online information system 130 when determining the reputation value for a user 105. For example, a user 105 who is preferred by more than ten members can have their reputation in the online information system 130 increased.

The interaction of the components of system 100 can be further illustrated through the use of a simplified example. A user 105 can log into the organization's online information system 130. Using the user interface 115 of the online information system 130, the user 105 can read Pam's blog entry 145 on error handlers. Having found this blog entry 145 useful, the user 105 reads other blog entries 145 by Pam and decides that Pam's blog has a lot of useful information for coding Web applications.

Therefore, the user 105 elects to prefer Pam's blog by selecting a menu item 125 from the user interface 115. The user 105 further specifies in their preference that they desire only blog entries 145 that are about JAVASCRIPT 148. As time passes, Pam adds more entries 145 to her blog. When she adds a blog entry 145 that has a keyword of JAVASCRIPT 148, the content preference service 160 notifies the user 105 of the blog entry 145.

It is important to note the characteristics of system 100 that contrast with the common methods of conventional information systems for providing contextually-preferred content items 145 to users 105. Using the above example as a background, in a conventional information system, in order for the user 105 to become aware of Pam's new blog entry 145 with the keyword JAVASCRIPT 148, the user 105 would have to perform a manual search on the keyword JAVASCRIPT 148 or have subscribed to Pam's blog. This embodiment of the present invention overcomes the undesired issues inherent in these approaches.

Performance of manual searches requires that the user 105 perform the search at least daily, if not more often, to become aware of the new content item 145 in a timely fashion. System 100 can eliminate this need and related issues of incongruent terminology. Subscribing to Pam's blog provides the user 105 with every entry of Pam's blog (automation without context). System 100 can also eliminate this problem by applying the user-defined content notification preferences 172 of the user 105 to each content item 145.

While this embodiment of the present invention can be applied to existing stores of content items 145, it is the intended nature for this embodiment of the present invention to collect user-defined content notification preferences 172 from users 105 in regards to existing content items 145 so that those user-defined content notification preferences 172 can be applied to future content items 145 added to the online information system 130.

Network 180 can include any hardware/software/and firmware necessary to convey data encoded within carrier waves. Data can be contained within analog or digital signals and conveyed though data or voice channels. Network 180 can include local components and data pathways necessary for communications to be exchanged among computing device components and between integrated device components and peripheral devices. Network 180 can also include network equipment, such as routers, data lines, hubs, and intermediary servers which together form a data network, such as the Internet. Network 180 can also include circuit-based communication components and mobile communication components, such as telephony switches, modems, cellular communication towers, and the like. Network 180 can include line based and/or wireless communication pathways.

As used herein, presented data stores 140 and 165 can be a physical or virtual storage space configured to store digital information. Data stores 140 and 165 can be physically implemented within any type of hardware including, but not limited to, a magnetic disk, an optical disk, a semiconductor memory, a digitally encoded plastic memory, a holographic memory, or any other recording medium. Data stores 140 and 165 can be a stand-alone storage unit as well as a storage unit formed from a plurality of physical devices. Additionally, information can be stored within data stores 140 and 165 in a variety of manners. For example, information can be stored within a database structure or can be stored within one or more files of a file storage system, where each file may or may not be indexed for information searching purposes. Further, data stores 140 and/or 165 can utilize one or more encryption mechanisms to protect stored information from unauthorized access.

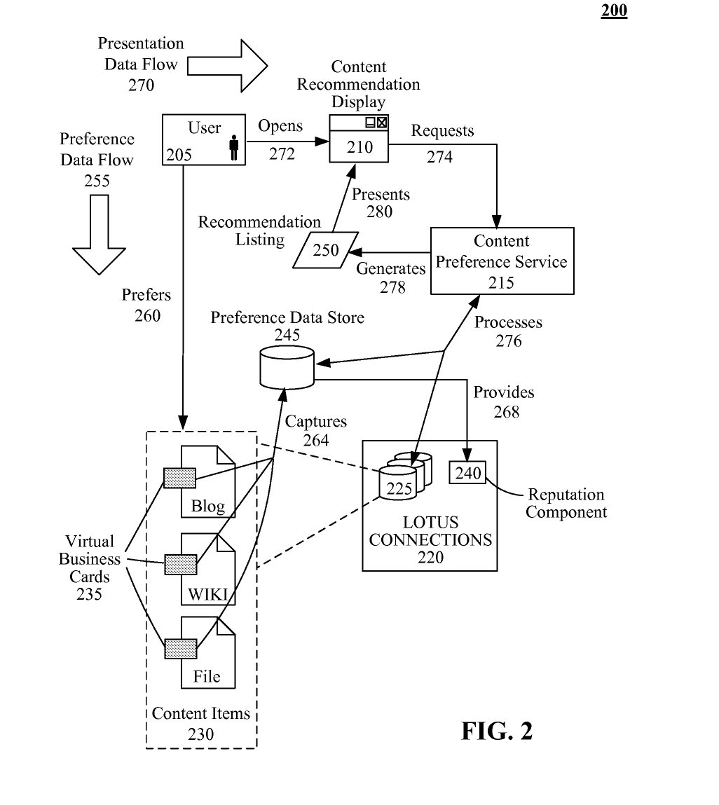

FIG. 2 is a schematic diagram illustrating two data flows 255 and 270 of a system 200 that utilizes a non-subscription based service 215 to provide contextually-preferred content to information system users 205 in accordance with embodiments of the inventive arrangements disclosed herein. The components illustrated in system 200 can represent a specific embodiment of system 100. The data flows 255 and 270 of system 200 can be performed within the context of system 100 or any other system configure to utilize a non-subscription based service to provide contextually-preferred content to information system users.

In system 200, the user 205 can access content items 230 contained in the data stores 225 of the LOTUS CONNECTIONS 220, a social networking system. A content preference service 215 can be utilized to provide the user 205 with contextually-preferential content items 230. These system 200 components 215 and 220 can correspond to the content preference service 160 and online information system 130 of system 100.

The preference data flow 255 can represent the data exchanges that occur in system 200 when the user 205 indicates preference of a content item 230. As such, the preference data flow 255 can start when the user 205 executes a prefer action 260 from the virtual business card 235 of a content item 230.

A virtual business card 235 can represent an interaction mechanism utilized within LOTUS CONNECTIONS 220 to present information about a specific content item 230 and/or a creator (not shown) of the content item 230. The virtual business card 235 can also contain various commands supported by LOTUS CONNECTIONS 220, such as a command to indicate preference of the content item 230.

Execution of the prefer action 260 can trigger a capture action 264 that stores the preference information of the user 205 and content item 230 within the preference data store 245. Optionally, a provide action 268 can then convey the preference information to a reputation component 240 of LOTUS CONNECTIONS 220.

The presentation data flow 270 can represent the data exchanges that occur in system 200 when a user 205 desires to view preferred content items 230. Presentation data flow 270 can begin when the user 205 opens 275 the content recommendation display 210. The content recommendation display 210 can request 274 the appropriate data to display from the content preference service 215.

The content preference service 215 can process 276 the content data stores 225 of LOTUS CONNECTIONS 220 with respect to the preferences contained within the preference data store 245 for the user 205. Once processing is complete, the content preference service 215 can generate 278 a recommendation listing 250. The content recommendation display 210 can then present 280 the recommendation listing 250 to the user 205.

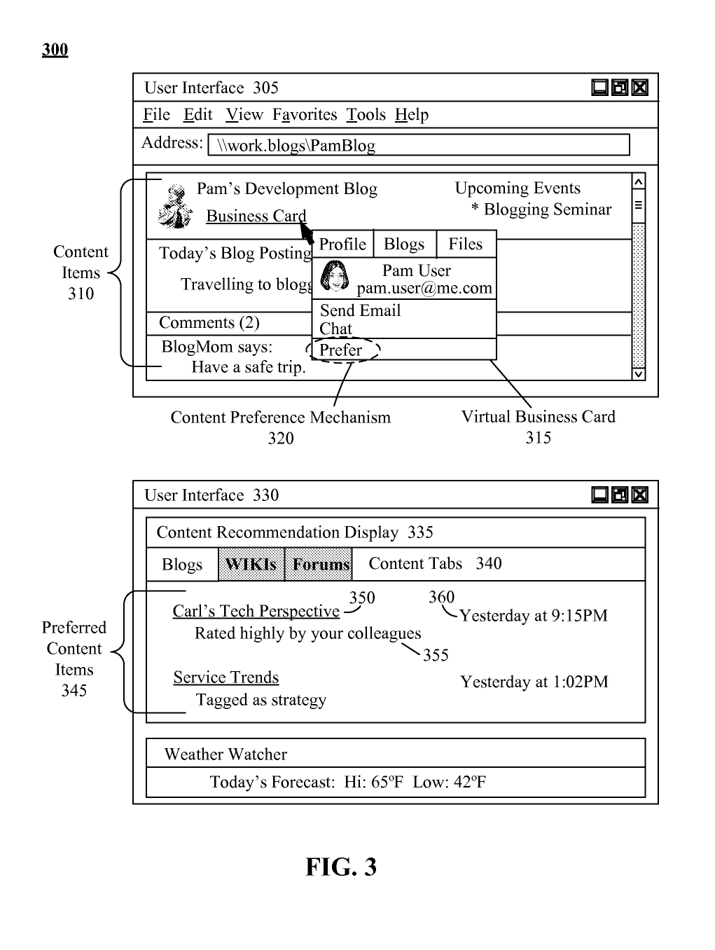

FIG. 3 is a collection 300 of graphical user interfaces (GUIs) 305 and 330 for an online information system that illustrate content preference service features in accordance with embodiments of the inventive arrangements disclosed herein. GUIs 305 and 330 can be utilized within the context of system 100 and/or the data flows 255 and 270 of system 200.

It is important to note that the GUIs 305 and 330 of collection 300 are for illustrative purposes only, and are not intended to present a comprehensive implementation of this aspect of the present invention.

GUI 305 can illustrate the presentation of content items 310 from the online information system. In this example, the content items 310 can correspond to the various data groupings of the Web log(blog), such as the daily posting and each posted comment. A user interested in defining a preference for content items 310 shown on the displayed Web page can select the content preference mechanism 320 contained within the virtual business card 315.

The content preference mechanism 320 can be configured to present a specialized interface window to further refine preference information when such refinements are supported by the content preference service and online information system.

GUI 330 can represent an example of the content recommendation display 335. The content recommendation display 335 can correspond to a single display area or component presented within the GUI 330, such as a widget of a dashboard display. The preferred content items 345 presented within the content recommendation display 335 can be organized by content type, with each content type presented in a separate content tab 340.

Information about each preferred content item 345 can be presented within the content recommendation display 335. In this example, each preferred content item 345 is presented with an identifier 350, a recommendation description 355, and an availability date 360. The identifier 350 can be a textual title or name associated with the preferred content item 345. Additionally, the identifier 350 can be utilized to act as a launch mechanism, such as a hyperlink, for the preferred content item 345.

The recommendation description 355 can describe to the user the reason the preferred content item 345 was selected (e.g., the user-defined content notification preference that was satisfied). The availability date 360 can indicate the date and/or time when the preferred content item 345 became available within the online information system.

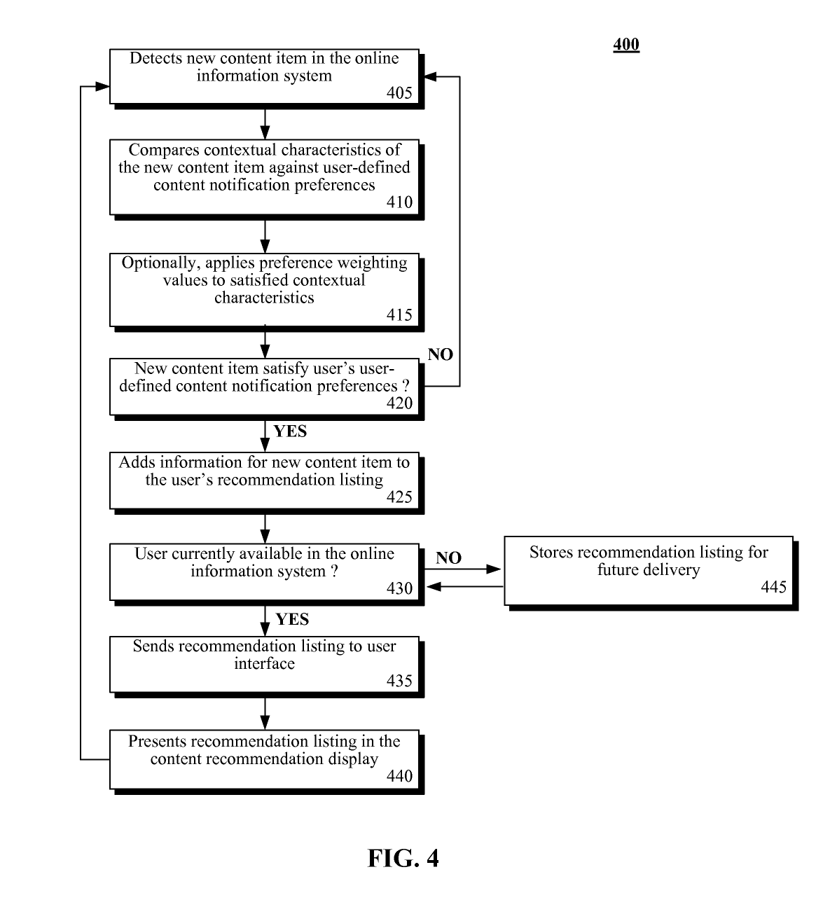

FIG. 4 is a flow chart of a method 400 that describes the basic operation of a non-subscription based content preference service in accordance with an embodiment of the inventive arrangements disclosed herein. Method 400 can be performed in the context of system 100, the data flows 255 and 270 of system 200, and/or utilizing the graphical user interfaces (GUls) 305 and 330 of collection 300.

Method 400 can begin with step 405 where the content preference service can detect a new content item in the online information system. The contextual characteristics of the new content item can be compared against user-defined content notification preferences in step 410. In step 415, preference weighting values can be optionally applied to satisfied contextual characteristics.

In step 420 it can be determined if the new content item satisfies a user's user-defined content notification preferences. When the user-defined content notification preferences are not satisfied, flow can return to step 405 where the content preference service can await detection of the next new content item.

When the user-defined content notification preferences are satisfied, the information for the new content item can be added to the user's recommendation listing in step 425. In step 430, it can be determined if the user is currently available in the online information system.

When the user is currently available, the recommendation listing can be sent to the user interface in step 435. In step 440, the recommendation listing can then be presented within the content recommendation display. From step 440, flow can return to step 405 where the content preference service can await detection of the next new content item.

When the user is currently unavailable, step 445 can execute where the content preference service stores the recommendation listing for future delivery. From step 445, flow can return to step 430, looping until the content preference service is able to deliver the recommendation listing. Alternately, the flow of method 400 can terminate with step 445 and not return to step 430, where delivery of the recommendation listing can be triggered by the user logging onto the online information system.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A non-subscription based system for providing contextually-preferred content to users comprising:
an online information system configured to provide access to a plurality of content items, wherein each content item is associated with at least one of a specific content creator registered with the online information system and a specific content organizational location of the online information system; and
a preferred content service provider configured to provide a content preference service to users of the online information system, wherein the content preference service is configured to provide a user with a recommendation listing of content items from the online information system that satisfies a predetermined level of user preference without use of a subscription mechanism, wherein the recommendation listing is dynamically updated when new content items meeting the predetermined level of user preference become available in the online information system.

2. The system of claim 1, wherein a content item comprises at least one of a Web log(blog) entry, a blog comment, an online forum posting, a WIKI entry, a WIKI entry modification, and an electronic file.

3. The system of claim 1, wherein the preferred content service provider further comprises:
a plurality of user-defined content notification preferences describing contextual characteristics of content items preferred by the user;
a content monitor configured to detect an availability of new content items within the online information system; and
a recommendation engine configured to assess the contextual characteristics of a new content item detected by the content monitor against the plurality of user-defined content notification preferences to determine inclusion of the new content item in the recommendation listing.

4. The system of claim 3, further comprising:
a content preference mechanism coupled with a user interface of the online information system configured to allow user-configuration of the plurality of user-defined content notification preferences; and
a content recommendation display component coupled with the user interface of the online information system configured to visually present the recommendation listing, wherein the presentation of the recommendation listing within the content recommendation display is performed separately and asynchronously from standard components of the user interface.

5. The system of claim 4, wherein the content preference mechanism utilizes a user-specific virtual business card profile that is incorporated into the online information system, wherein the content preference mechanism is presented as an option within a presentation of the user-specific virtual business card within the user interface.

6. The system of claim 3, wherein the contextual characteristics utilized within the plurality of user-defined content notification preferences comprise at least one of an identifier of the specific content creator, one or more textual tags associated with the content item, a user rating of the content item, and the specific content organizational location of the content item within the online information system.

7. The system of claim 3, wherein the plurality of user-defined content notification preferences further comprises:
a plurality of preference weighting values configured to define a degree of preference for a specific contextual characteristic; and
a preference threshold value configured to define a minimum limit for the predetermined level of user preference.

8. The system of claim 3, wherein the contextual characteristics of the plurality of user-defined content notification preferences are provided to and utilized by a reputation system when determining a content reputation score for the user, wherein the reputation system is a component of the online information system.

9. The system of claim 1, wherein the recommendation listing comprises at least one of an identifier of a content item, a storage location of the content item, a date at which the content item became available, a hyperlink by which to access the content item, and a recommendation description.

10. A method for providing contextually-preferred content to users comprising:
detecting an existence of a new content item within an online information system, wherein the new content item has at least one associated contextual characteristic comprising at least one of an identifier of a creator of the new content item, one or more textual tags associated with the new content item, a user rating of the new content item, and a location of the new content item within the online information system;
in response to the detection, determining a satisfaction of a predetermined level of user preference by the at least one contextual characteristic associated with the new content item, wherein said determination is performed for each user of the online information system having a value for the predetermined level of user preference; and
when the new content item satisfies the predetermined level of user preference for a user, providing said user with a dynamically generated recommendation listing that details an availability of the new content item within a user interface of the online information system, wherein said provision of the dynamically generated recommendation listing occurs without prompting by a subscription mechanism.

11. The method of claim 10, wherein the detection of new content items, determination of the satisfaction of the predetermined level of user preference, and the providing of the dynamically generated recommendation listing are performed by a preferred content service provider, wherein said preferred content service provider functions independently and asynchronously from the online information system.

12. The method of claim 11, wherein the preferred content service provider is a component of the online information system.

13. The method of claim 10, wherein the determination of the satisfaction of the predetermined level of user preference further comprises:
accessing at least one user-defined content notification preference associated with the user, wherein the at least one user-defined content notification preference comprises a plurality of contextual characteristics describing content items preferred by the user; and
comparing the at least one contextual characteristic of the new content item to a value of a corresponding contextual characteristic contained within the at least one user-defined content notification preference.

14. The method of claim 13, further comprising:
when the comparison of the value of a contextual characteristic of the new content item indicates satisfaction of a user-defined content notification preference, optionally applying a preference weighting value to the satisfied user-defined content notification preference;
aggregating a preference level from the satisfied user-defined content notification preferences; and
comparing the preference level against a user-defined preference threshold value.

15. The method of claim 10, further comprising:
in response to a user-selection of a content preference mechanism for an existing content item within the user interface of the online information system, receiving at least one contextual characteristic of the existing content item from the online information system; and
storing the received at least one contextual characteristic as a user-defined content notification preference in a storage location associated with the user.

16. The method of claim 10, wherein the new content item comprises at least one of a Web log(blog) entry, a blog comment, an online forum posting, a WIKI entry, a WIKI entry modification, and a file upload.

17. A non-subscription based online information system service for automatically providing contextually-preferred content to users comprising a computer readable storage medium having computer usable program code embodied therewith, the computer usable program code comprising:
computer usable program code configured to detect an existence of a new content item within an online information system, wherein the new content item has at least one associated contextual characteristic comprising at least one of an identifier of a creator of the new content item, one or more textual tags associated with the new content item, a user rating of the new content item, and a location of the new content item within the online information system;
computer usable program code configured to, in response to the detection, determine a satisfaction of a predetermined level of user preference by the at least one contextual characteristic associated with the new content item, wherein said determination is performed for each user of the online information system having a value for the predetermined level of user preference; and
computer usable program code configured to, when the new content item satisfies the predetermined level of user preference for a user, provide said user with a dynamically generated recommendation listing that details an availability of the new content item within a user interface of the online information system, wherein the providing of the dynamically generated recommendation listing occurs without prompting by a subscription mechanism.

18. The non-subscription based online information system service of claim 17, wherein the determination of the satisfaction of the predetermined level of user preference further comprises:
computer usable program code configured to access at least one user-defined content notification preference associated with the user, wherein the at least one user-defined content notification preference comprises a plurality of contextual characteristics describing content items preferred by the user; and
computer usable program code configured to compare the at least one contextual characteristic of the new content item to a value of a corresponding contextual characteristic contained within the at least one user-defined content notification preference.

19. The non-subscription based online information system service of claim 18, further comprising:
computer usable program code configured to, when the comparison of the value of a contextual characteristic of the new content item indicates satisfaction of a user-defined content notification preference, optionally apply a preference weighting value to the satisfied user-defined content notification preference;
computer usable program code configured to aggregate a preference level from the satisfied user-defined content notification preferences; and
computer usable program code configured to compare the preference level against a user-defined preference threshold value.

20. The non-subscription based online information system service of claim 17, further comprising:
computer usable program code configured to, in response to a user-selection of a content preference mechanism for an existing content item within the user interface of the online information system, receive at least one contextual characteristic of the existing content item from the online information system; and
computer usable program code configured to store the received at least one contextual characteristic as a user-defined content notification preference in a storage location associated with the user.
